(19) United States
(12) Patent Application Publication
(10) Pub. No.: US 2007/0156665 A1
(43) Pub. Date: Jul. 5, 2007

(54) Taxonomy discovery

(76) Inventor: Janusz Wnek, Germantown, MD (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 10/883,746

(22) Filed: Jul. 6, 2004

Related U.S. Application Data
(63) Continuation-in-part of application No. 09/683,263, filed on Dec. 5, 2001, now Pat. No. 7,113,943.

(51) Int. Cl. G06F 17/30

(52) U.S. Cl. 707/4

(57) ABSTRACT

Discovering a taxonomy of a subset of a collection of documents by preprocessing a document collection; calculating a vector space for the preprocessed document collection; and grouping and labeling at least a first level of a taxonomy of a subset of the collection.

### CROSS REFERENCE TO RELATED APPLICATIONS

The present application claims priority to the following pending U.S. Patent application as a Continuation-In-Part, and incorporates the disclosure of this application herein in its entirety.

09/683,263 Method for Document Comparison and Selection, filed Dec. 05, 2001; published as U.S. Patent Application 20020103799 Aug. 01, 2002.

The present application incorporates the disclosure of the following U.S. Patents herein in their entirety.

U.S. Pat. No. 6,678,679 Method and System for Facilitating the Refinement of Data Queries, issued Jan. 13, 2004.

U.S. Pat. No. 5,301,109 Computerized Cross-Language Document Retrieval Using Latent Semantic Indexing, issued Apr. 05, 1994.

U.S. Pat. No. 4,839,853 Computer Information Retrieval Using Latent Semantic Structure, issued Jun. 13, 1989.

### FIELD OF THE INVENTION

Preferred embodiments of the invention relate to the discovery of taxonomy inherent in the latent semantic content of a subset of a collection of documents and labeling the groups in the taxonomy with descriptive titles.

### BACKGROUND

Inductive learning from examples is a powerful paradigm for generalizing and predicting set membership of objects. It aims at breaking a learning problem into a set of concepts and finding training examples to instantiate the conceptualization. However, it may not be easy to find useful conceptual categories that are useful for organizing training examples for applications such as computer learning, in part because human perception of concept organization is often quite different from the understanding of a machine learning system. What is needed to respond to this difficulty, and to the general problem of organizing collections of information, is a method, system, or computer program product for discovering a taxonomy inherent in a collection of information or in a subset thereof.

### BRIEF SUMMARY OF THE INVENTION

In preferred embodiments, the invention includes a method for discovering a taxonomy of a subset of a collection of documents. The method includes the steps of preprocessing a document collection; calculating a vector space for the preprocessed document collection; and grouping and labeling at least a first level of a taxonomy of a subset of the collection. In some embodiments, grouping and labeling further include: determining a preliminary group in a first level of the taxonomy; labeling the preliminary group; refining the preliminary group; and removing documents assigned to the refined group from consideration for membership in other groups at this level of the taxonomy.

### BRIEF DESCRIPTION OF THE DRAWINGS

Each drawing is exemplary of the characteristics and relationships described thereon in accordance with preferred embodiments of the present invention.

FIG. 1 illustrates a method of discovering a taxonomy.

FIG. 2 illustrates a method of identifying and labeling groups of a taxonomy

FIG. 3 illustrates a matrix of measurements of document similarity used in grouping documents.

### DETAILED DESCRIPTION

As required, detailed embodiments of the present invention are disclosed herein. It is to be understood that details and features of the disclosed embodiments are exemplary of the invention that may be embodied in various and alternative forms. The figures are not necessarily to scale, and some features may be exaggerated or minimized to show details of particular components. Details disclosed herein are not to be interpreted as limiting, but merely as a basis for the claims and as a representative basis for teaching one skilled in the art to variously employ the present invention. In preferred embodiments, components are individually and collectively configured and interrelated as described herein.

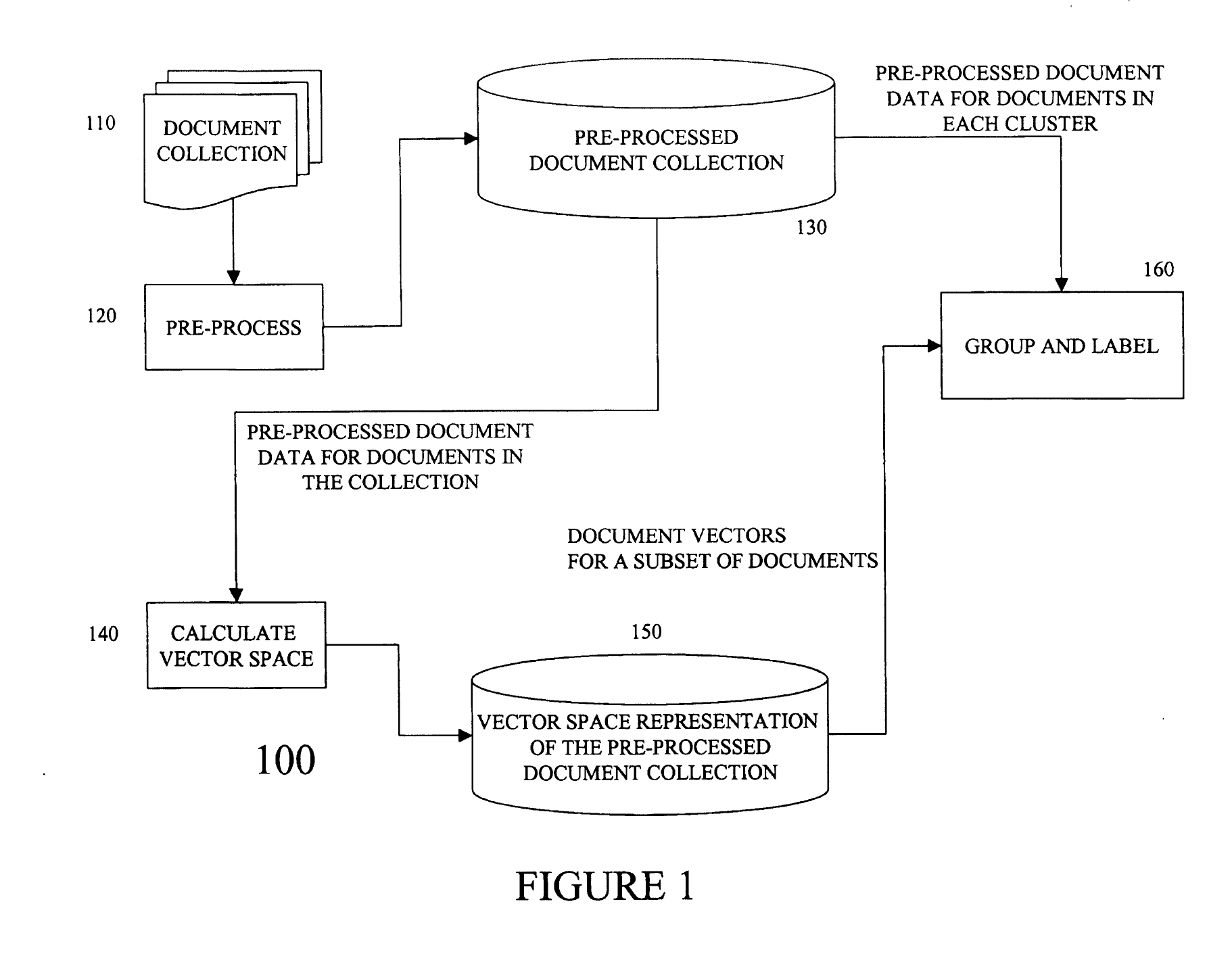

Referring to FIG. 1, a preferred embodiment 100 of the present invention is shown. In such embodiments, a document collection 110 is pre-processed 120 for removal of stop words, stemming, and development of generalized entities. U.S. Patent Publication 20020103799 entitled Method for Document Comparison and Selection, discloses methods for extracting phrases between stop words, stemming the phrase words, and the creation of generalized entities.

“Entity” includes semantic units from one to several words in length that can be treated as a single “term” during latent semantic indexing (LSI). A generalized entity is a semantic unit comprising a short phrase or one or more words, preferably stemmed. While entities can contain long strings of individual terms, in preferred embodiments of the present invention, entities longer than one word are connected into bi-words, i.e., two-word pairs, during pre-processing. Experience has shown that two-word pairs are sufficient to facilitate reconstruction of longer original phrases. Consider, for example, the phrase “value decomposition method.” If bi-words “value*decomposition” and “decomposition*method” occur a similar number of times (or with similar frequency), then there is increased confidence that “value decomposition method” is a semantically meaningful phrase—this without constructing the three-word group “value*decomposition*method.”

Examples of pre-processing 120 performed in preferred embodiments of the invention include the following. In one type of preprocessing, an input stream filter reads an input stream to determine the encoding and mime-type from the data associated with the stream. This encoding is used to translate the incoming stream into plain text. For example, ff the mime-type is found to be either text/html or text/xml then pre-processing filters the hypertext markup language (HTML) or extensible markup language (XML) to extract plain text. In another type of pre-processing, a word parser parses characters into words, e.g., using Java's BreakIterator capabilities. This pre-processing provides several options to filter the data such as removing stop words and removing numeric or other undesired word types. It can also enable/disable preserving case of characters. A stop-phrase parser can be used to read an input stream of words and remove stop-phrases from them. A stop-phrase is one or more words that together in sequence make up a phrase that should be removed from the stream. When used in a pipeline, the usual way to get stop-phrases to this filter is to reference a document containing list of stop-phrases. A stop-word parser reads an input stream of words and removes stop-words from them if a stop-word set is provided. A stemmer word parser filters words by passing them through a stemmer.

The preprocessed documents and entities 130 are indexed 140 into a vector space 150, preferably a latent semantic index (LSI) vector space or a derivative thereof U.S. Pat. No. 4,839,853 to Deerwester, et al., entitled Computer Information Retrieval Using Latent Semantic Structure, discloses methods and uses of a such a preferred space.

In some embodiments, an existing vector space representation may have been developed as part of a larger collection of documents. For example, in a vector space representing a collection of all U.S. patents, patents related to motorcycles were represented along with patents related to toasters. If the subset of interest is patents related to motorcycles, the “all U.S. patent” vector space (with preprocessing as indicated above), can be used. This approach requires less computational resources than calculating a new vector space to discover a taxonomy directed to motorcycle patents alone.

In some embodiments, a vector space 150 is created from the results of a query. For example, a query on “motorcycle” to the LSI space containing all U.S. patents may return ten thousand (10,000) document identifiers (potentially some of the corresponding documents not containing the word “motorcycle”). A result-specific vector space 150 can then be created using the document identifiers returned in response to the query and the corresponding raw document data maintained in the collection 110. This database can take advantage of result specific pre-processing 110 such as a result-domain stop word list.

Experimental trials indicate that, other than with regard to need for computing resources, the quality of the resulting taxonomy does not significantly deteriorate when using the representation of the subset in a larger original space, or creating a new space with the subset itself.

Referring again to FIG. 1, groups are identified and labeled 160 for a subset of interest from the vector space representation 150 of the preprocessed document collection 130. Note that the subset can be all the indexed documents in the vector space representation 150.

A wide range of known clustering techniques can be used in embodiments of the invention to identify groups Survey of Clustering Data Mining Techniques (Berkhin, B. (2002) Accrue Software, http://citeseer.nj.nec.com/berkhin02survey.html, San Jose, Calif.—accessed Jul. 7, 2004) identifies such techniques. Preferred embodiments of the invention utilize clustering identifiable as hierarchical clustering where an N×N connectivity matrix comprises measures of similarities between documents

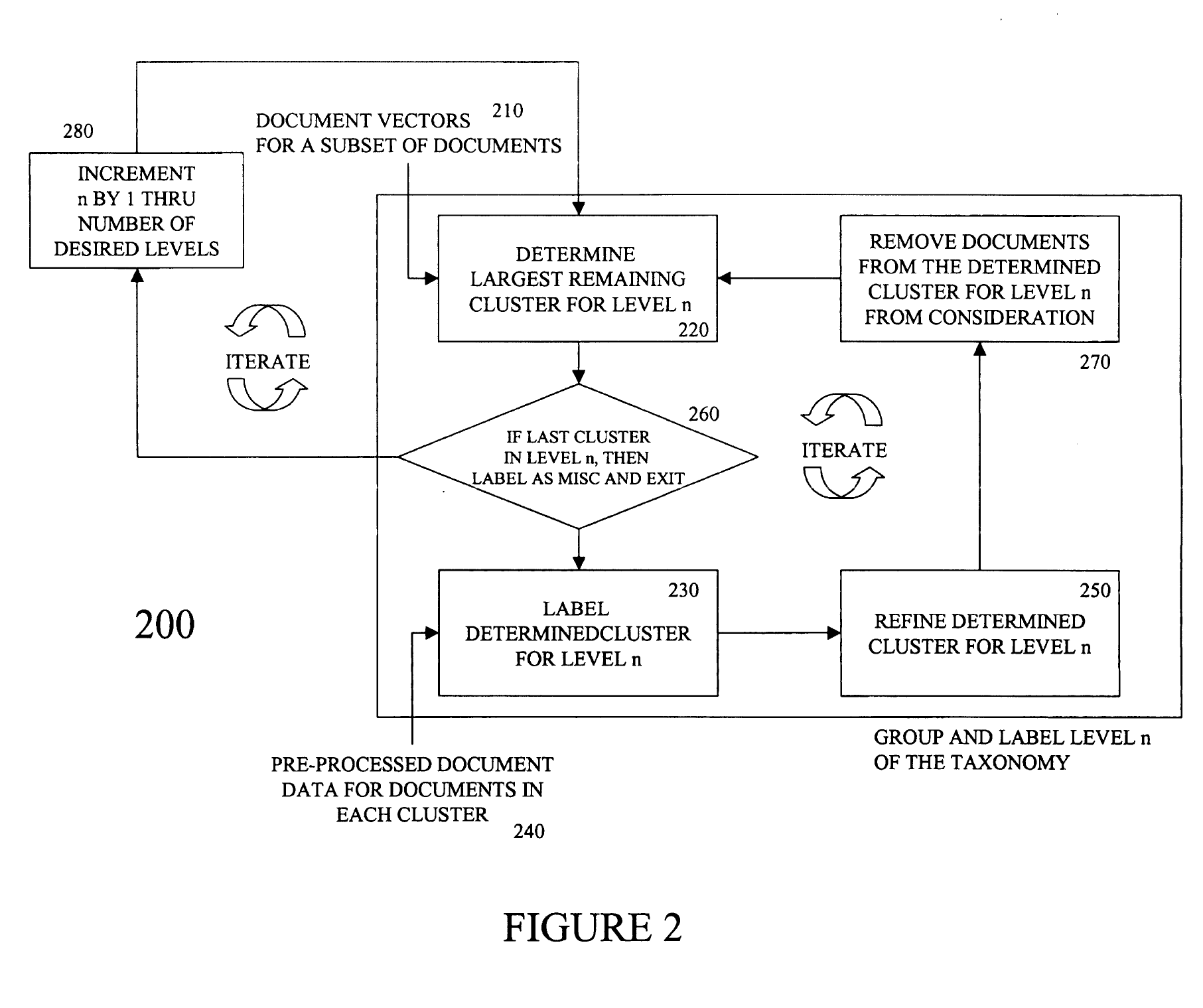

Referring to FIG. 2, an exemplary diagram illustrating a “breadth first” approach to identifying and labeling groups of a taxonomy 200 is shown. While preferred embodiments of the invention proceed to identify and label groups having a common parent from the largest preliminary group (see 210 and FIG. 2 generally) to the smallest before moving to the next parent in the level and before moving to the next lower level (an ordered “breadth first” approach), other approaches (such as identifying and labeling all groups within a level across parents from the next higher level) are within the scope of the invention. Specifically, preferred embodiments include “depth-first” approaches where groups in one lineage are first labeled all the way (or part way) down the lineage, then other unlabeled lineages with the same parent are labeled before moving on to other unlabeled groups in higher levels of the taxonomy. In each case, the principles illustrated in FIG. 2 and described herein apply.

In some embodiments of the invention, document grouping is realized by clustering together documents that are similar in terms of the cosine measure between vectors representing the documents. The vectors for documents in the subset of interest 210 are readily available from the vector space index 150. Some embodiments reduce the dimensionality of the vector space to dimensions relevant to the query for which the taxonomy is constructed. To this end, the query is represented as a vector in the LSI space and dimensions that have values above a threshold are selected as relevant.

In determining a cluster 220, embodiments of the invention calculate (or assemble if such calculations have already been done and are available) an array of similarities between pairs of N documents. Some of these embodiments make the N×N array sparse by ignoring elements that do not exceed a minimum cosine measure. The initial set of clusters is detected for documents that hold a similarity above a threshold. This approach maximizes the sum of the average pair-wise similarities between the documents assigned to each cluster, weighted according to the size of the cluster. In preferred embodiments (in part in order to prevent a low threshold from forming too-large clusters) the threshold is selected so that two thirds (⅔) of the documents can be assigned to clusters with at least four (4) members.

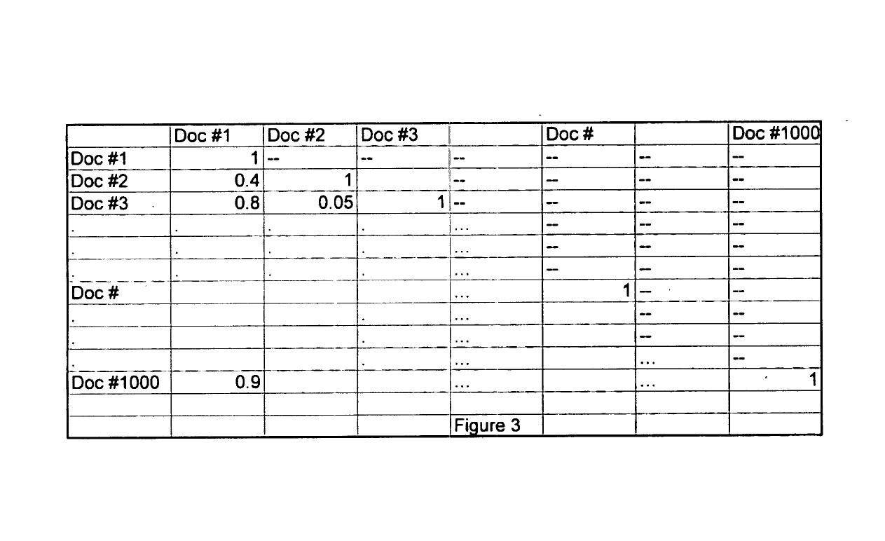

For example, where the index 150 comprises vectors representing the location of one thousand (1000) documents in an LSI vector space, a 1000×1000 matrix is constructed where a given entry (i,j) represent the cosine of the angle between the vectors for document i and document j. FIG. 3 illustrates a portion of such a matrix. As illustrated in FIG. 3, for a cosine closeness threshold of 0.5, Document #1 could be found with, inter alia, Document #3 and Document # 1000 in a cluster containing the largest number of documents 210. Document #1 (or alternately any other member of the largest cluster) can serve as a preliminary marker for the cluster. The cluster being a preliminary group. In preferred embodiments, the largest cluster detected in this step is processed first. In preferred approaches to grouping, a final miscellaneous group of documents that are otherwise not related is formed 260 and labeled as such.

In preferred embodiments, topic titles (group labels) for non-final clusters are determined 230 based on common entities found among the documents included in a particular cluster. In some embodiments, common entities are sorted according to three counts in the following fashion: the number of documents in which the entity is included; the number of words constituting the entity, and the frequency of occurrence of the entity. The ordered entities are further tested and rejected if applicable. One test checks if the entity is on a topic exclusion list. Another test can exclude the entity if it is included in at least a certain number of documents outside the cluster, e.g. if the ratio of in-cluster references to references external to the cluster is greater than a threshold. Note that such sorting this does not have to be an LSI exercise, but can be a use of preprocessing results 240 on the clustered documents.

If the entity with the best sort result is part of a multiword generalized entity, examining individual words in the bi-word and searching for a fitting bi-word with overlapping words can be used to determine the remaining part. In preferred embodiments, matching bi-words having similar coverage, e.g., similar number of documents in which the entities are present, are identified in order to reconstruct then as a generalized entity. Preferred parameters of similarity between bi-words includes a range of the ratio of the number of document for each bi-word. For example, with a range threshold of 0.75 to 1.33, bi-word AB occurring in 75 documents and bi-word BC occurring in 100 documents, ABC would be reconstructed as a three-word generalized entity.

Next, the generalized entity is reconstructed to reflect the most common usage, e.g., lead word or phrase including stop words and other symbols, among the documents in the cluster. This way, the original word formatting, including connecting stop-words is restored. This allows reconstruction of topic titles such as, ‘United States of America,’ or ‘Composer J.S. Bach.’ Reconstruction of bi-words in this fashion does not require the complete raw document text. Text fragments spanning words comprising the generalized entity with stop-words and other filtered words/characters/symbols are sufficient for reconstruction.

Some embodiments label a group with more than just the lead word or phrase, e.g., the first few lead words or phrases may be shown.

In preferred embodiments, preliminarily determined groups are refined 250. In some embodiments, only documents within a particular cluster are reexamined to determine if membership in the group remains appropriate after labeling. For example, documents that do not include the group label can be removed from the cluster and considered for membership in subsequent clusters. Note that if more than one lead word or phrase is used to label a group and all such labels are considered at this point, documents that do not contain the lead word or phrase, but contain a subsequent label element, will remain included in the group.

In other embodiments, all of the subset documents are examined to find the group label. When a document not previously a member of the group in question is found, it is tested to determine if it belongs to an already-identified group. If it does not and the group label is found in the document, it is assigned to the group in question. In some embodiments, even if the document belongs to an already-identified group, the distance between this document and its already-identified group is compared to the distance between the document and the group in question. If the document is closer to the cluster in question than a threshold amount, then the document is reassigned to the cluster in question.

In preferred embodiments, documents assigned to a refined group can be removed 270 from consideration for membership in subsequent other groups at this level of the taxonomy. Subsequent groups are identified and labeled until the last group in the level or lineage under consideration is determined.

After a group is assigned a label, the group is further split into sub-groups and sub-group labels are generated using the same method. The labels can be presented to a user in the form of a concept hierarchy. The hierarchy summarizes the contents of the subset of documents in terms of concepts organized by the generality or “part-of” relationship. In a breath-first approach, identification of the last cluster in a level will cause the level to be incremented 280 and the process of grouping and labeling proceeds to the next level. In some embodiments, the existing N×N matrix of document similarity is reused.

In the process of generating a hierarchy, preferred embodiments can consult two exclusion lists in addition to the ones mentioned above. The first list prevents the same topic title from being assigned to siblings. The second list prevents the same topic title from being used twice in a given lineage.

In some embodiments, users can interact with the invention for purposes such as: removing documents from consideration in the collection; remove entities from consideration as labels; remove groups of the hierarchy; and even reassigning groups to a different lineage (though this last interaction can disrupt the “discovered” nature of the taxonomy).

In preferred embodiments, a system of the invention operates as one or more processes of a computer program product having functionality described above and hosted on one or more platforms in communication over a network. In some embodiments, the system employs a typical client-server architecture. The architecture can be realized either on a single, multiprocessing computer with the client connecting to the server locally, or multiple computers connected in a network. The network can include one server and many clients. In some installations, the server functionality may be realized on a grid of computers to increase computational power, e.g. to execute singular value decomposition (SVD), an element of LSI, for large document collections.

In some embodiments, the invention includes a web server providing an interface for clients, an application server for supplying a platform to host the system's management components, and the LSI backend providing the core functionality of the system. Optionally, remote host application managers can interact with the application server for providing additional Content Analyst components to be remotely available to the system. These components can reside on a single host or distributed among several hosts.

Preferred embodiments employ an interface based on Enterprise Java Bean (EJB) technology. The use of Java language and EJB technology facilitates hardware and operating system independence since the technology has been made available for all major platforms, such as Windows, Unix, and Linux. In turn, the document taxonomy can be run under a Java application, applet, or Java Service Provider (JSP) pages.

Embodiments of the invention are capable of generating taxonomies for documents in various languages. Language-dependent processing is carried in the preprocessing stages where based on the text locale, the text is converted to an universal character encoding, e.g. UTF8, as well as proper stop-word list and stemmers are loaded from the system resource library.

In preferred environments a web server provides HTML web pages and downloadable Java client applications for managing the system. Users may interact with the system through the HTML web pages via a web browser or download a Content Analyst Java client application using the Java Web Start technology. These Java applications access the web server for user authentication and controlling the management components residing on the application server. In addition to client connectivity, the web server is also used by the system for storage and retrieval of the document text added to the system. The web server may be available as part of the application server or as a separate entity.

The application server provides a J2EE environment for system management components. A J2EE application server, such as JBoss or Weblogic, manages Enterprise JavaBeans (EJB). Embodiments of the invention utilize EJBs for managing the system (e.g. repositories, documents, users, system parameters), as well as interacting with the LSI backend. The LSI backend provides the core LSI operations to the system such as index creation, document preprocessing, and query hosting.

The remote host application managers in the system may operate on additional nodes in a network. A host running an application manager allows distributed repositories to exist separately from the application server, which provides additional flexibility in sharing the resource load in the system. In addition, the manager provides a mechanism for running automated operations to interact with the system.

Embodiments of the invention can be used to discover a taxonomy of results returned in response to a query from a collection. For example, organizing a set of results returned in response to a query or as post-processing of search results to organize the results in a meaningful way.

Embodiments of the invention can also be used in concept-driven information retrieval, where certain documents representative of a group are used as one or more exemplars in a classification scheme. Exemplars can be used to classify documents in a collection completely different than the original collection. A taxonomy of the present invention in combination with exemplars can constitute an ontology for concept driven document classification.

1. A computer-based method for generating a taxonomy of a collection of documents, comprising:
generating a term-by-document matrix for the collection of documents;
generating a vector for each document in the collection of documents based on the term-by-document matrix;
identifying document clusters based on similarity comparisons between pairs of the vectors;
identifying labels for the document clusters based on generalized entities included in documents of the document clusters; and
storing the labels in an electronic format accessible to a user.

2. The computer-based method of claim 6, wherein identifying labels for the document clusters based on generalized entities included in documents of the document clusters comprises:
determining a preliminary group in a first level of the hierarchical document clusters;
labeling the preliminary group;
refining the preliminary group; and
removing the documents assigned to the preliminary group from consideration for membership in other groups in the first level of the hierarchical document cluster.

3. A computer program product comprising a computer usable medium having computer readable program code stored therein that causes an application program for generating a taxonomy of a collection of documents to execute on an operating system of a computer, the computer readable program code comprising:
computer readable first program code for causing the computer to generate a term-by-document matrix for the collection of documents,
computer readable second program code for causing the computer to generate a vector for each document in the collection of documents based on the term-by-document matrix;
computer readable third program code for causing the computer to identify document clusters based on similarity comparisons between pairs of the vectors;
computer readable fourth program code for causing the computer to identify labels for the document clusters based on generalized entities included in documents of the document clusters; and
computer readable fifth program code for causing the computer to store the labels in an electronic format accessible to a user.

4. The method computer program product of claim 12, wherein the computer readable fourth program code further comprises:
code for causing the computer to determine a preliminary group in a first level of the hierarchical document cluster;
code for causing the computer to label the preliminary group;
code for causing the computer to refine the preliminary group; and
code for causing the computer to remove documents assigned to the preliminary group from consideration for membership in other groups in the first level of the hierarchical document cluster.

5. A system for generating a taxonomy of a collection of documents, comprising:
a plurality of processors that each communication with at least one other processor in the plurality of processors over a network; and
a computer program product comprising a computer usable medium having computer readable program code stored therein that causes an application program for generating a taxonomy of a collection of documents to execute on at least one of the processors in the plurality of processors, wherein the computer program product includes
computer readable first program code for causing the computer to generate a term-by-document matrix for the collection of documents;
computer readable second program code for causing the computer to generate a vector for each document in the collection of documents based on the term-by-document matrix,
computer readable third program code for causing the computer to identify document clusters based on similarity comparisons between pairs of the vectors,
computer readable fourth program code for causing the computer to identify labels for the document clusters based on generalized entities included in documents of the document clusters,
computer readable fifth program code for causing the computer to transmit the labels over the network.

6. The computer-based method of claim 1, wherein identifying document clusters based on similarity comparisons between pairs of the vectors comprises:
identifying hierarchical document clusters based on similarity comparisons between pairs of the vectors.

7. The method of claim 1, wherein identifying document clusters based on similarity comparisons between pairs of the vectors comprises:
identifying a first document and a second document as members of a first document cluster if a similarity between the vector corresponding to the first document and the vector corresponding to the second document exceeds a threshold.

8. The method of claim 1, wherein identifying labels for the document clusters based on generalized entities included in documents of the document clusters comprises:
sorting entities based on at least one of (i) a number of documents that include the respective entities, (ii) a number of words included in the respective entities, and (iii) a frequency of occurrence of the respective entities.

9. The method of claim 1, wherein identifying labels for the document clusters based on generalized entities included in documents of the document clusters comprises:
excluding one or more entities included on an exclusion list.

10. The method of claim 1, wherein identifying labels for the document clusters based on generalized entities included in documents of the document clusters comprises:
excluding one or more entities as a label for a first document cluster if the one or more entities are included in a predetermined number of documents not included in the first document cluster.

11. The method of claim 1, further comprising:
displaying the labels to a user in a concept hierarchy.

12. The computer program product of claim 3, wherein the computer readable third program code comprises:
code for causing the computer to identify hierarchical document clusters based on similarity comparisons between pairs of the vectors.

13. The computer program product of claim 3, wherein the computer readable fourth program code comprises:
code for causing the computer to identify a first document and a second document as members of a first document cluster if a similarity between the vector corresponding to the first document and the vector corresponding to the second document exceeds a threshold.

14. The computer program product of claim 3, wherein the computer readable fourth program code comprises:
code for causing the computer to sort entities based on at least one of (i) a number of documents that include the respective entities, (ii) a number of words included in the respective entities, and (iii) a frequency of occurrence of the respective entities.

15. The computer program product of claim 3, wherein the computer readable fourth program code comprises:
code for causing the computer to exclude one or more entities included on an exclusion list.

16. The computer program product of claim 3, wherein the computer readable fourth program code comprises:
code for causing the computer to exclude one or more entities as a label for a first document cluster if the one or more entities are included in a predetermined number of documents not included in the first document cluster.

17. The computer program product of claim 3, further comprising code to cause the computer to display the labels to a user in a concept hierarchy.

18. The system of claim 5, wherein the computer readable fourth program code further comprises:
code for causing the computer to determine a preliminary cluster in a first level of the hierarchical document cluster;
code for causing the computer to label the preliminary group;
code for causing the computer to refine the preliminary group; and
code for causing the computer to remove documents assigned to the preliminary group from consideration for membership in other groups in the first level of the hierarchical document cluster.

19. The system of claim 5, wherein the computer readable third program code comprises:
code for causing the computer to identify hierarchical document clusters based on similarity comparisons between pairs of the vectors.

20. The system of claim 5, wherein the computer readable third program code comprises:
code for causing the computer to identify a first document and a second document as members of a first document cluster if a similarity between the vector corresponding to the first document and the vector corresponding to the second document exceeds a threshold.
